(19) United States
(12) Patent Application Publication
(10) Pub. No.: US 2016/0059251 A1
(43) Pub. Date: Mar. 3, 2016

(54) Airbrush

(71) Applicant: Gbemisola Yewanbe Ogunyomi, Houston, TX (US)

(72) Inventor: Gbemisola Yewanbe Ogunyomi, Houston, TX (US)

(21) Appl. No.: 14/470,920

(22) Filed: Aug. 27, 2014

(51) Int. Cl. B05B 7/24

(52) U.S. Cl. CPC B05B 7/2416; B05B 7/2408

(57) ABSTRACT

An improved airbrush can comprise a housing and an airbrush assembly. The housing can comprise a front housing and a back housing. The airbrush assembly can be mounted on or within the front housing. The airbrush assembly can comprise a reservoir, a trigger, a nozzle, a needle, an air valve, and an air pump. The nozzle can be placed at the front end of the front housing in fluid connection with the reservoir. The needle can connect the reservoir, the nozzle, and the trigger. The nozzle can be placed at the front end of the needle. The reservoir at the middle section of the needle, and the trigger can be near the back end of the needle. The air valve can be mounted within the front housing. The air pump and battery can be within the back housing.

### BACKGROUND

This disclosure relates to an improved airbrush.

Today, airbrushes have been a widely used medium for various art applications, which includes makeup application, t-shirt design, and painting among others. An airbrush is a hand-held device that uses air to form a mist with a liquid material. Such technique can allow user to apply an even coating of liquid to any medium. Airbrushes operate by connecting an airbrush to an air compressor. Such method can be effective but is bulky and not very portable.

Additionally, liquid content used in an airbrush is usually placed within a reservoir on the device. This is the most common method used for containing liquid content for airbrush. However, using such method does not properly utilize the liquid content since the liquid can end up dropping in the walls of the airbrush reservoir. Moreover, some liquid content tends to stick within the walls of the bottle therefore causing waste on the liquid product.

As such it would be useful to have an improved airbrush.

### SUMMARY

An improved airbrush is herein disclosed. The improved airbrush can comprise a housing and an airbrush assembly. The housing can comprise a front housing and a back housing. The airbrush assembly can be mounted on the front housing. The airbrush assembly can comprise a reservoir, a trigger, a nozzle, a needle, an air valve, and an air pump. The reservoir can be mounted to the outside of the housing. The reservoir can comprise a chamber. The nozzle can be placed at the front end of the front housing in fluid connection with the reservoir. The needle can connect the chamber, the nozzle, and the trigger. The nozzle can be placed at the front end of the needle. The reservoir at the middle section of the needle, and the trigger can be near the back end of the needle. The air valve can be mounted within the front housing. The air valve can be vertically connected with the trigger. The air pump can be mounted within the inner surface of the back housing. The air pump can comprise an inlet and an outlet. The outlet can be directly connected below the air valve.

### BRIEF DESCRIPTION OF THE DRAWINGS

FIG. 1A illustrates an airbrush.

FIG. 1B illustrates a cross-sectional view of a pen-shaped embodiment of an airbrush.

FIG. 2A illustrates an embodiment of an airbrush wherein a back housing is mounted vertically behind a front housing.

FIG. 2B illustrates a cross-sectional view of an airbrush having a vertical back housing.

FIG. 3A illustrates an airbrush comprising an attachable back housing.

FIG. 3B illustrates a cross-sectional view of an attachable back housing.

FIG. 4A illustrates another embodiment of a back housing.

FIG. 4B illustrates a cross-sectional view of a back housing embodiment.

FIG. 5 illustrates an embodiment of a reservoir.

FIG. 6A illustrates an embodiment of a cartridge comprising a puncturable tip, and a body.

FIG. 6B illustrates a cartridge being punctured.

FIG. 7A illustrates another embodiment of a reservoir comprising a puncture device.

FIG. 7B illustrates a top view of a puncture device.

FIG. 8 illustrates another embodiment of a cartridge wherein puncturable tip is re-sealable.

FIG. 9 illustrates a cartridge mounted into an airbrush on to a puncture device.

FIG. 10 illustrates an embodiment of a cartridge held in a reservoir with a plurality of mounting brackets.

### DETAILED DESCRIPTION

Described herein is an improved airbrush. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

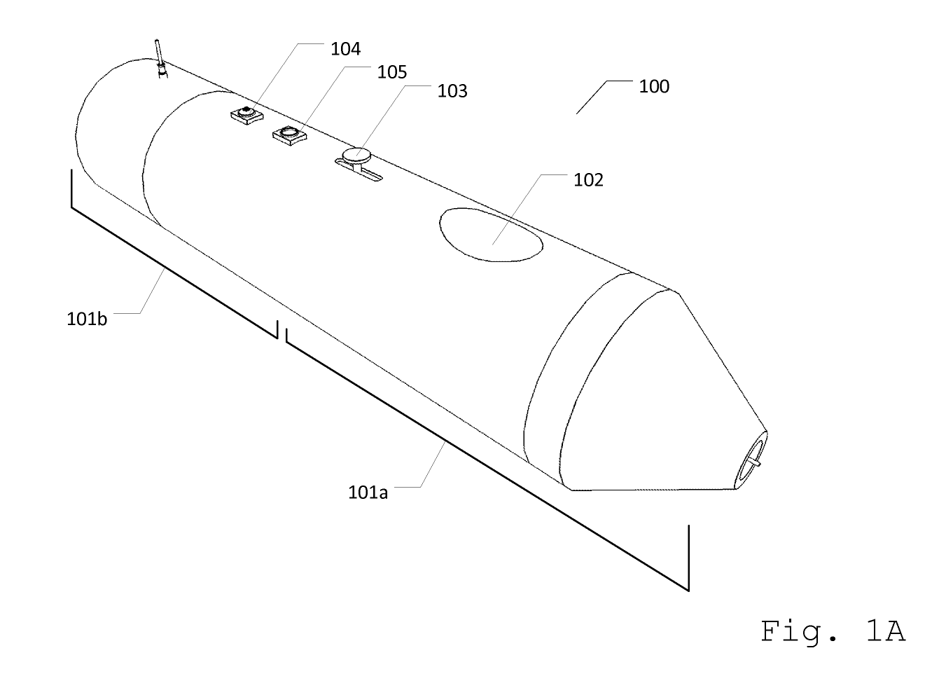

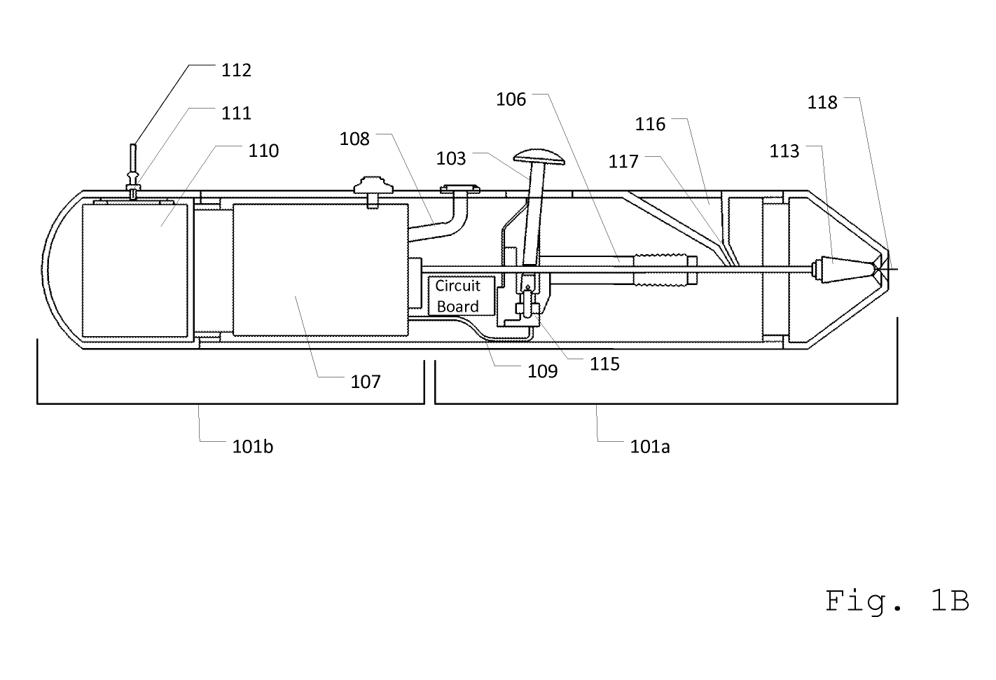

FIG. 1A illustrates an airbrush 100. Airbrush 100 can comprise a housing 101. Housing 101 can comprise a front housing 101a, and a back housing 101b. In one embodiment, front housing 101a and back housing 101b can be unibody. As such, front housing 101a, and back housing 101b can be a single enclosure. The outer surface of front housing 101a can comprise a reservoir 102, and a trigger 103. Reservoir 102 can resemble a cup container wherein a liquid content can be inserted. For purposes of this disclosure, liquid content can include any material used for airbrush application such as makeup, ink, dye, or paint. In one embodiment, reservoir 102 can be placed at the top of front housing 101a or within front housing 101a. Trigger 103 can be an actuator such as a lever, which is used to control the air pressure released from an air pump. Trigger 103 can be placed at the top of housing 101. In such position, trigger 103 can be accessible when a user grips airbrush 100 through back housing 101b. This can allow back housing 101b be used as a handle. Moreover back housing 101b can allow user to easily hold and control airbrush 100. In this embodiment, front housing 101a and back housing 101b can be substantially cylindrical in form.

Housing 101 can further comprise an on/off switch 104 and a regulator 105. On/off switch 104 can allow airbrush 100 to turn on or off. Regulator 105 can allow user to control the airflow released by airbrush 100. In this embodiment, on/off switch 104, and a regulator 105 can be placed on the outer surface of housing 101. This structure can allow user to easily access on/off switch 104, and a regulator 105 using the same hand that holds airbrush 100.

FIG. 1B illustrates a cross-sectional view of a pen-shaped embodiment of airbrush 100. The inner surface of housing 101 can further comprise an airbrush assembly 106, and an air pump 107. Airbursh assembly 106 includes the inner mechanical components downstream from air pump 107 that functionally move a liquid from pump 107 to outside airbrush 100. In this embodiment, airbrush assembly 106 can be mounted within front housing 101a while air pump 107 can be mounted within back housing 101b. Air pump 107 can be used for pushing air through airbrush 100. Air pump 107 can be any type of mini air pumps such as an MPD-24A, or BTC miniature diaphragm pump. Moreover, air pump 107 can comprise an air inlet 108, and an air outlet 109. In one embodiment air inlet 108 can be connected through an orifice at the outer surface of housing 101. In another embodiment, air inlet 108 can receive flow of air within airbrush 100. In one embodiment, air pump 107 can be connected to a power source through a cord. In this embodiment, airbrush 100 can be plugged into a power source to turn on air pump 107. Further in another embodiment, airbrush 100 can further comprise a battery 110. In such embodiment, battery 110 can be connected to air pump 107 thus providing power for the air pump's operation. Furthermore, battery 110 can be mounted within back housing 101b. In this embodiment, battery 110 can be connected beside air pump 101. In such structure, back housing 101b can be horizontally connected with said front housing 101a. Battery 110 can be rechargeable. In such embodiment, airbrush 100 can further comprise a charging port 111. In another embodiment, a power cord 112 can be permanently connected to device to power pump.

Airbrush 100 can comprise reservoir 102, trigger 103, a nozzle 113, a needle 114, and an air valve 115. Reservoir 102 can comprise a dish 116 and a chamber 117. Dish 116 can form a depressed circular portion at the outer surface of airbrush 100. Chamber 117 can comprise a narrow shaft that connects dish 116 with needle 114. Nozzle 113 can be placed at the front end of front housing 101a. Moreover, nozzle 113 can be where the airflow and liquid content is exhausted. Needle 114 can extend from nozzle 113 to the rear end of front housing 101b. Needle 114 can comprise a tip 118. Tip 118 can be at the front-end portion of needle 114. Tip 118 can be enclosed within nozzle 113. Furthermore, tip 118 can control the reduction of fluid pressure released from nozzle 113. Air valve 115 can be vertically connected with trigger 103. Air valve 115 can be connected with air outlet 109. Thus, when trigger 103 is actuated air valve 115 can open, and air from air outlet 109 can flow within housing 101. Concurrently, needle 114 can slide back from nozzle 113 and liquid content from reservoir 102 can be released.

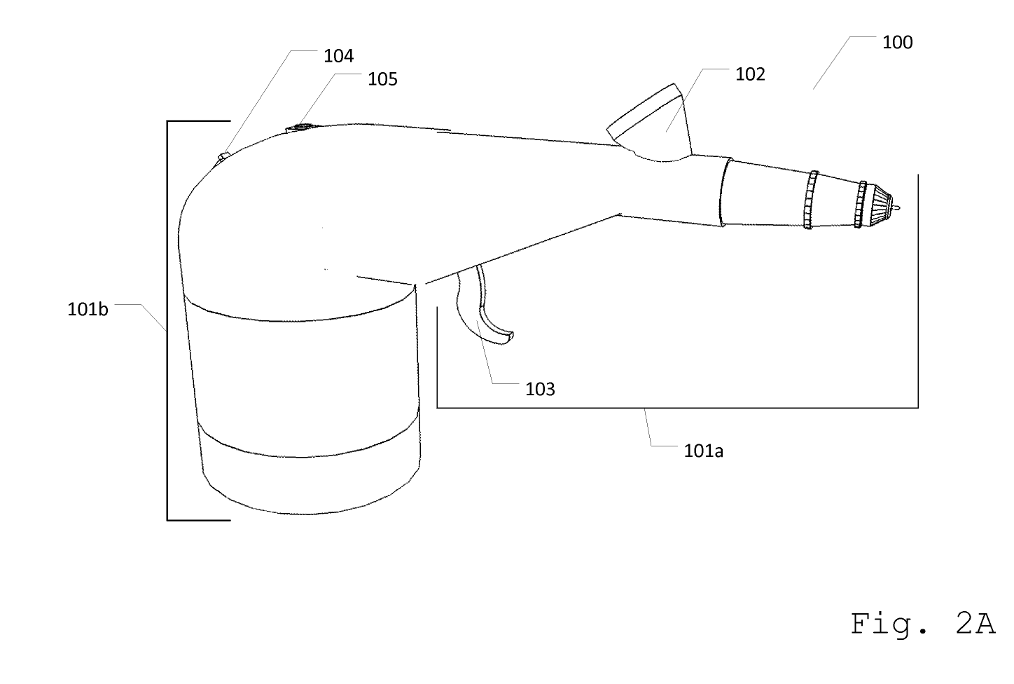

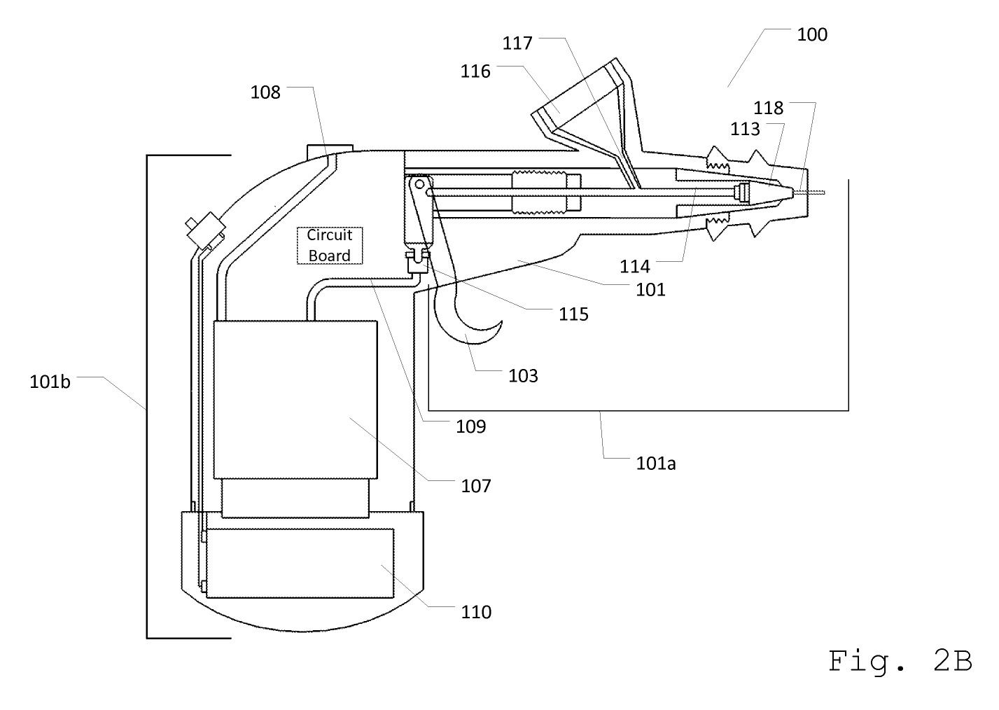

FIG. 2A illustrates an embodiment of airbrush 100 wherein back housing 101b is mounted vertically behind front housing 101a. In this embodiment, back housing 101b can extend downward and perpendicular to the front housing 101a. In this embodiment, trigger 103 can be placed directly in front of back housing 101b. Furthermore, on/off switch 104, and regulator 105 can be on the outer surface of housing 101.

FIG. 2B illustrates a cross-sectional view of airbrush 100 having a vertical back housing 101b. In this embodiment, battery 110 can be connected at the bottom of air pump 107. In such structure, back housing 101b can be vertically perpendicular with said front housing 101a. This can allow air outlet 109 be vertically connected to air valve 115. Therefore, when trigger 103 is pulled backwards, air valve 115 can move upward allowing air from air pump 107 to flow within housing 101.

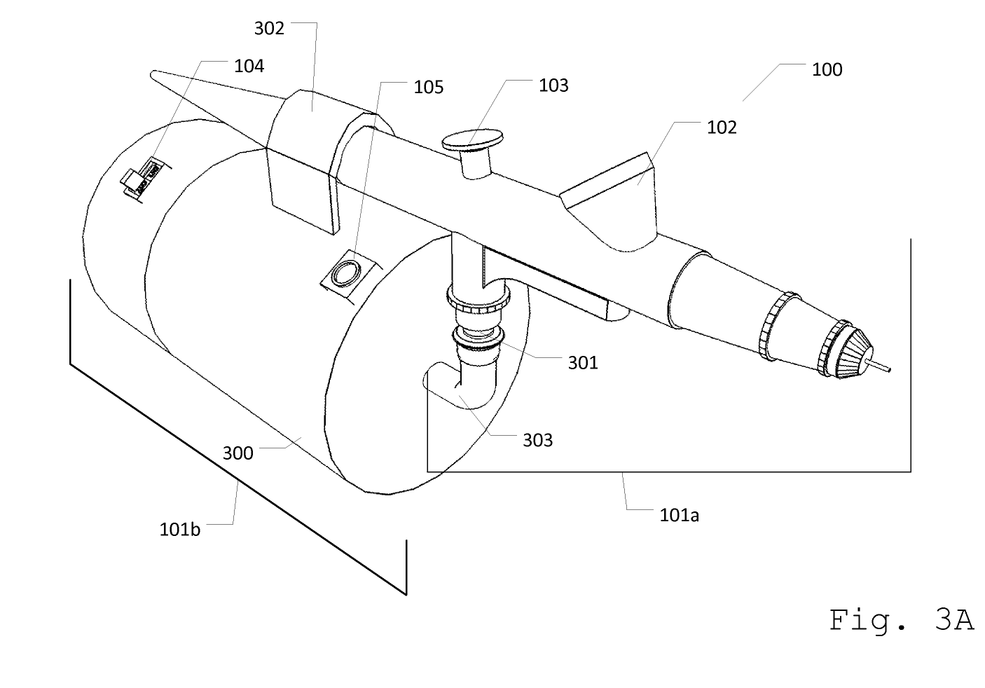

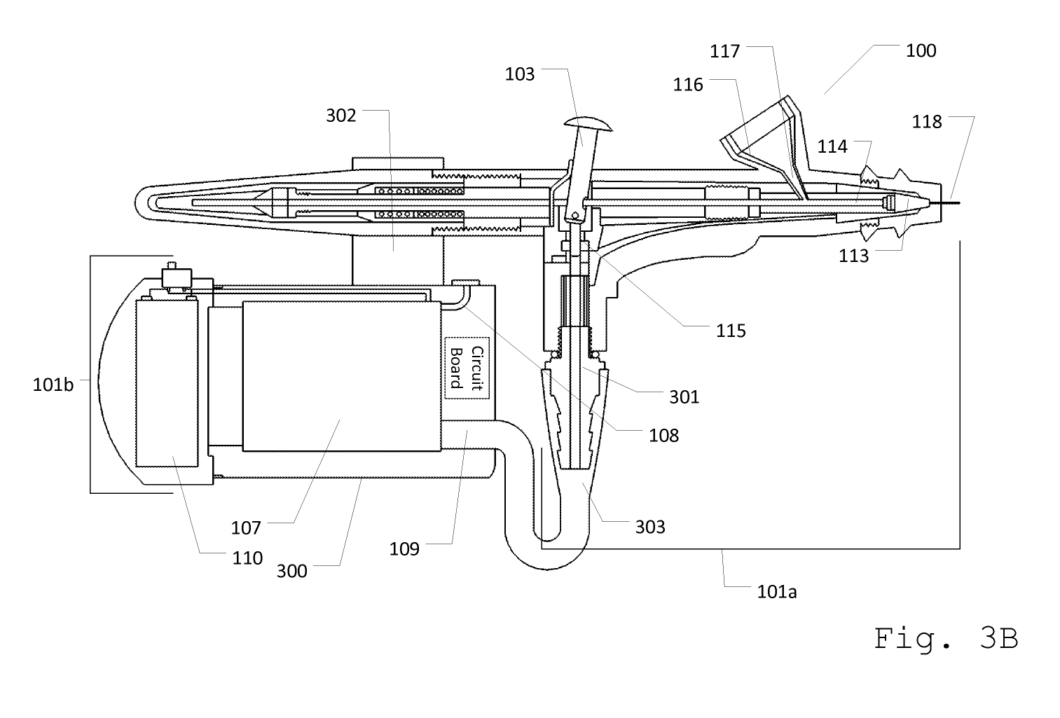

FIG. 3A illustrates airbrush 100 comprising an attachable back housing 101b. A cord port 301 can provide a path for air outlet 109 from back housing 101b to front housing 101a. Further in this embodiment, back housing 101b can be rectangular housing made of durable and lightweight material that can include but is not limited to plastic, and metal. In such embodiment, back housing 101b can be a separate device from airbrush 100. Furthermore, air pump enclosure 300 can comprise a fastening device 302 and an air outlet connector 303. Fastening device 302 can be placed at the top of air pump enclosure 300. Moreover, fastening device 302 can be any type of fastening mechanism that include but is not limited to a clamp, or a clasp, in one embodiment. In another embodiment, fastening device 302 can comprise an elastic material such as rubber. In this embodiment, fastening device 302 can fit snugly around the back end portion of front housing 101a. This structure can prevent fastening device 302 from slipping off the back end portion of front housing 101a. Air outlet connector 303 can be mateable with air outlet 109. In one embodiment, air outlet connector 303 can comprise a threaded portion compatible with cord port 301. In another embodiment, air outlet connector 303 can be made of elastic material that can securely wrap around cord port 301 of airbrush 100. In such embodiments, air outlet connector 303 can connect air outlet 109 of air pump 173 with air valve 115 of airbrush 100. Further in this embodiment, on/off switch 104, and regulator 105 can be placed at the back portion of air pump enclosure 300. This can allow on/off switch 104, and regulator 105 accessible to the user.

FIG. 3B illustrates a cross-sectional view of attachable back housing 101b. In this embodiment, air pump 107 and battery 110 can be enclosed within back housing 101b. Air pump 107 can be placed beside battery 110. Air outlet 109 can be connected with air outlet connector 303 while air inlet 108 can be connected to an orifice at the outer surface of air pump enclosure 300. In this embodiment, back housing 101b can be horizontally attachable at the back portion of airbrush 100. Air outlet connector 303 can be mateable at the bottom portion of cord port 301. This can connect air outlet 109 with air valve 115.

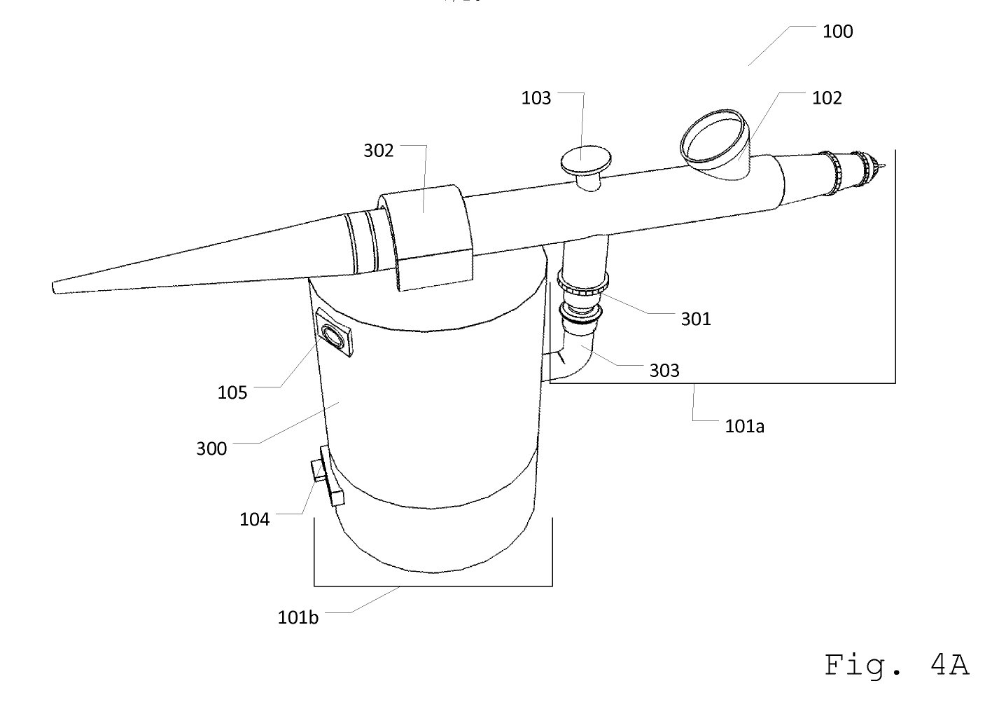

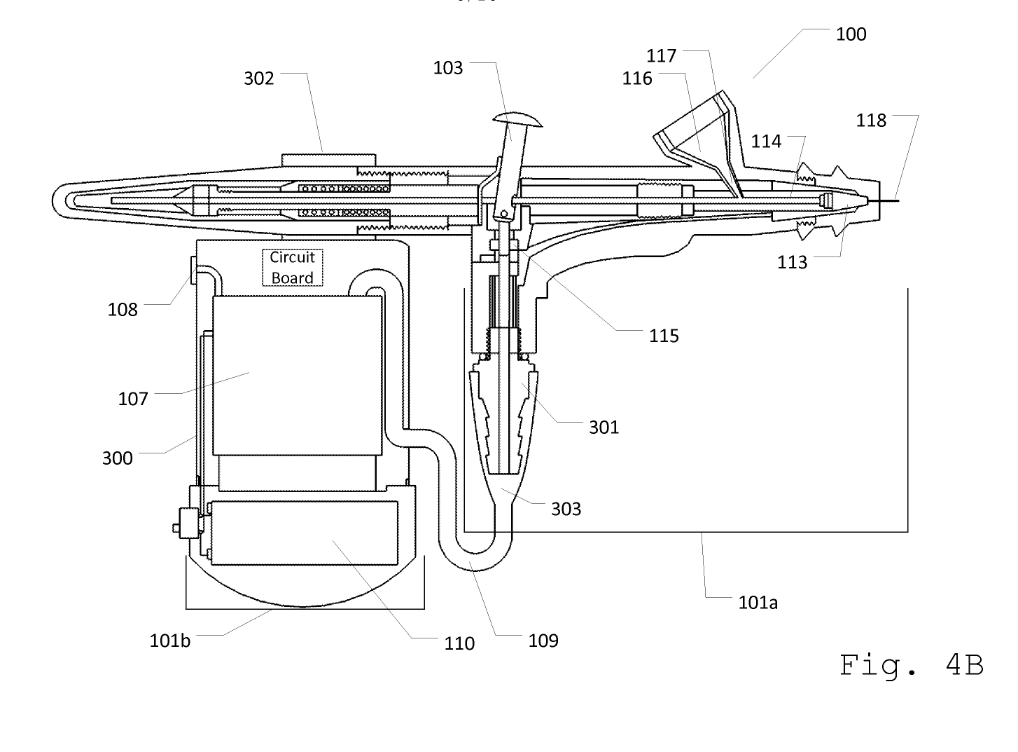

FIG. 4A illustrates another embodiment of back housing 101b. In this embodiment, back housing 101b can be vertically attached with airbrush 100 through fastening device 302.

FIG. 4B illustrates a cross-sectional view of back housing 101b embodiment. In this embodiment, air pump 107 and battery 110 can be enclosed within back housing 101b. Air pump 107 can be mounted within the inner top section of back housing 101b while battery 110 can be mounted at the inner bottom section. This can allow back housing 101b be vertically attached at the back portion of airbrush 100. Furthermore, air outlet 109 can be connected with air outlet connector 303, which can allow air outlet connector 303 mateable with cord port 301 of airbrush 100. Further, air inlet 108 can be connected to an orifice at the outer surface of back housing 101b.

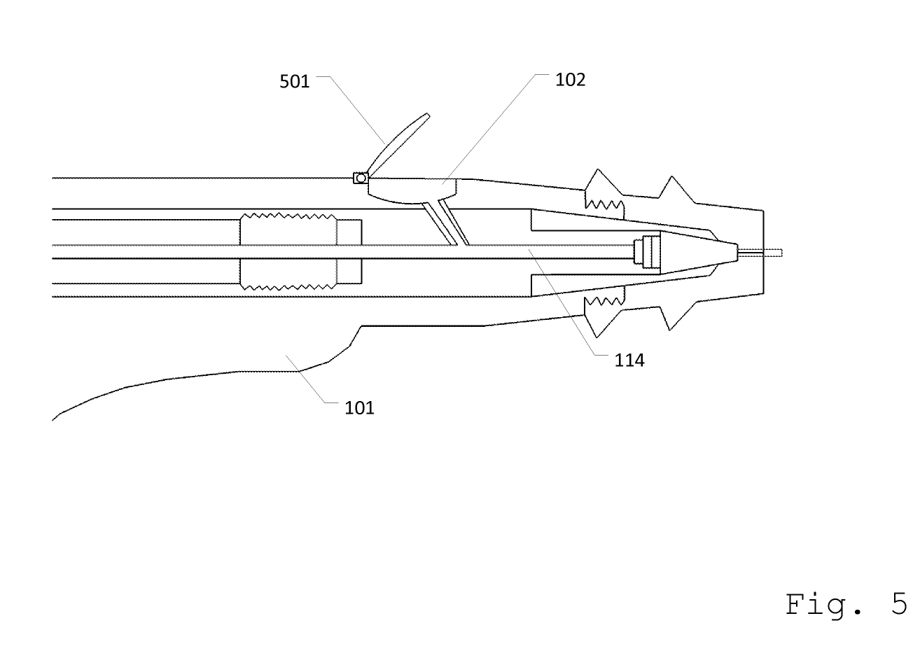

FIG. 5 illustrates an embodiment of reservoir 102. In this embodiment, reservoir 102 can be enclosed within housing 101. In such embodiment, reservoir 102 can be mounted at the inner surface of front housing 101a and connected with needle 114. Reservoir 102 can comprise a cover 501, in one embodiment. Cover 501 can be hinged at the top of reservoir 102 and can prevent liquid from escaping reservoir 102, in one embodiment.

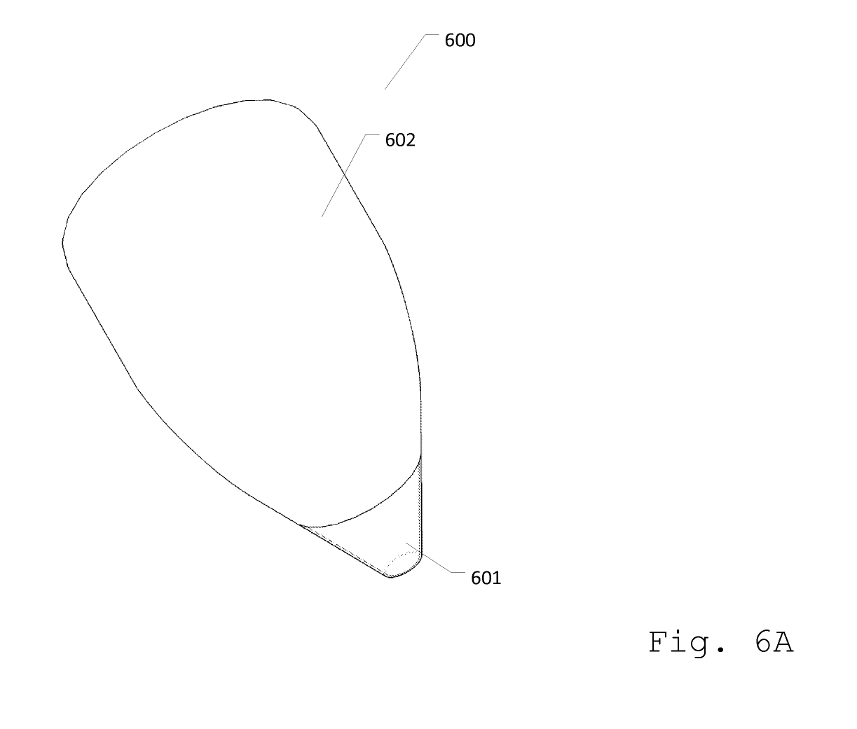

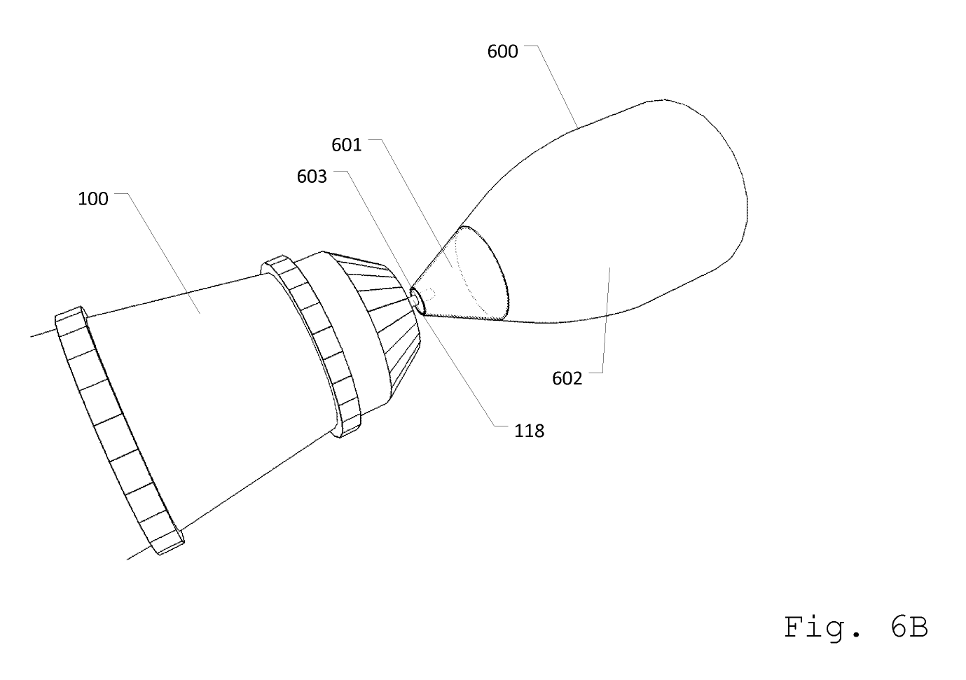

FIG. 6A illustrates an embodiment of a cartridge 600 comprising a puncturable tip 601, and a body 602. Cartridge 600 can be a container for liquid content that can include but is not limited to ink, paint, and makeup. Cartridge 600 can be made of an elastic durable material that can include but is not limited to rubber, plastic, or collagen. Body 602 can be the portion of cartridge 600 that contains liquid content. In this embodiment, body 602 can have a shape that is compatible with reservoir 102, such as conical or rectangular in shape. Puncturable tip 601 can mount at a portion of body 102. In one embodiment, puncturable tip 601 can be mounted at the tip of body 602.

FIG. 6B illustrates cartridge 600 being punctured. In this embodiment, puncturable tip 601 can be puncturable through a pointed device such as a needle. In another embodiment, to open puncturable tip 601, puncturable tip 601 can be pushed against tip 118 of airbrush 100. Once punctured, puncturable tip 601 can provide an opening 603. Opening 603 can allow liquid within body 602 be released within reservoir 102 and into airbrush 100. In such embodiments, puncturable tip 601 can first be mounted into reservoir 102. Since cartridge 600 can be in the shape of reservoir 102, puncturable tip 601 can be properly positioned within reservoir 102, which can release liquid content within airbrush assembly 106. This can also prevent spillage of liquid content within dish 116 of reservoir 102.

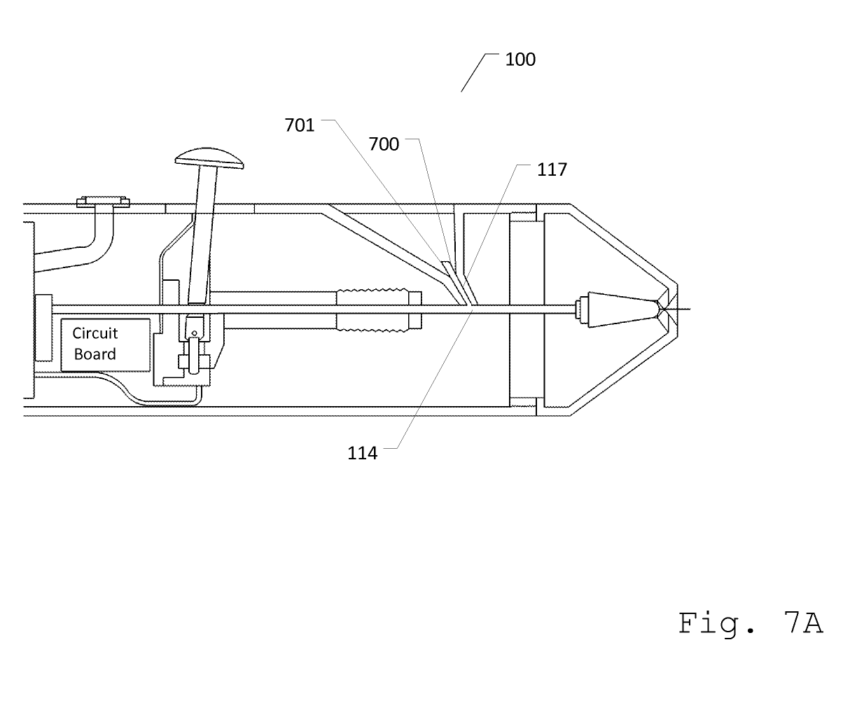

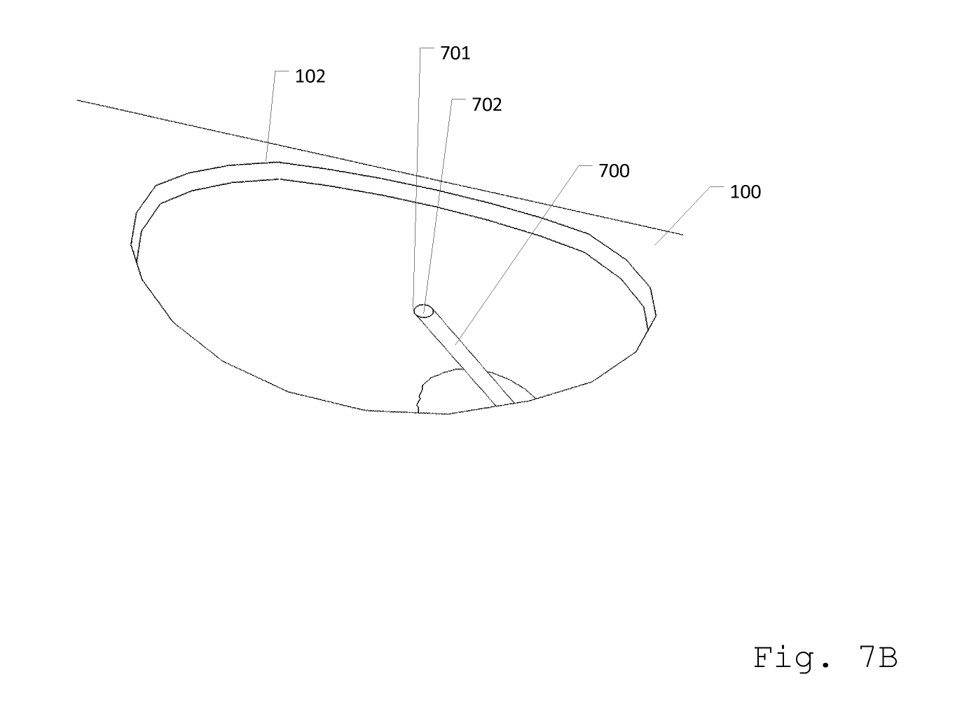

FIG. 7A illustrates another embodiment of reservoir 102 comprising a puncture device 700. Puncture device 700 can be a hollow tube that comprises a sharp tip 701. Puncture device 700 can be mounted within chamber 117 of reservoir 102. In such structure, puncture device 700 can be connected with needle 114 of airbrush 100.

FIG. 7B illustrates a top view of puncture device 700. Puncture device 700 can further comprise hole 702. In such structure, once cartridge 600 is mounted into reservoir 102, puncture device 700 can cut through cartridge 600 that can allow the liquid from body 602 to flow through hole 702 into the inner portion of airbrush 100.

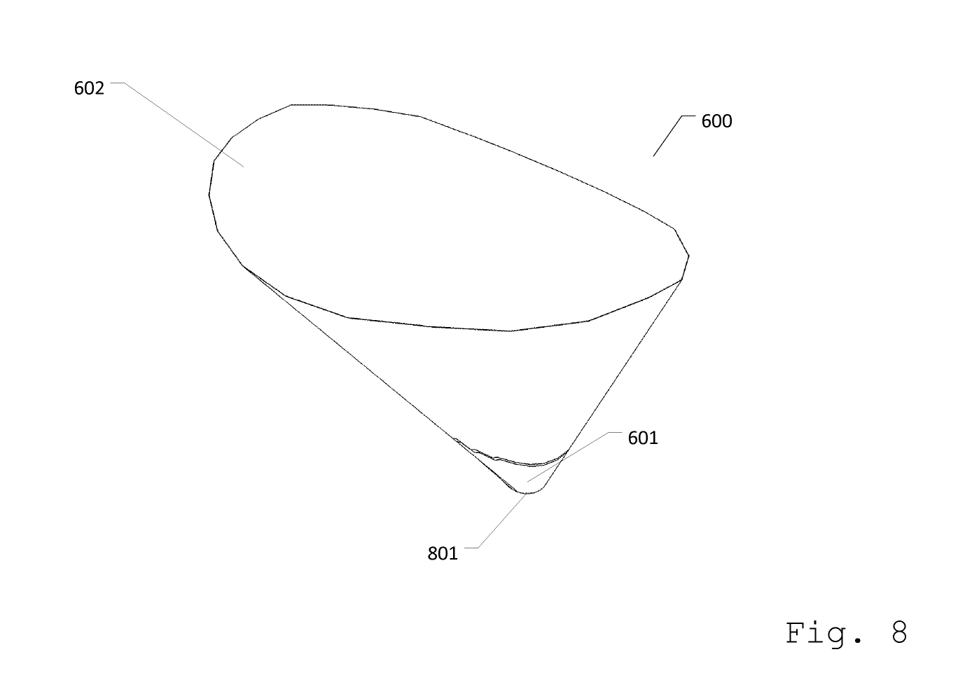

FIG. 8 illustrates another embodiment of cartridge 600 wherein puncturable tip 601 is re-sealable. Puncturable tip 601 can comprise a rubber stopper 801. Rubber stopper 801 can be placed at the tip of puncturable tip 601. In one embodiment, rubber stopper 801 can be bromobutyl rubber and/or chlorobutyl rubber. After a needle pierces rubber stopper 801 and is removed, rubber stopper 801 can reseal automatically preventing fluid from spilling.

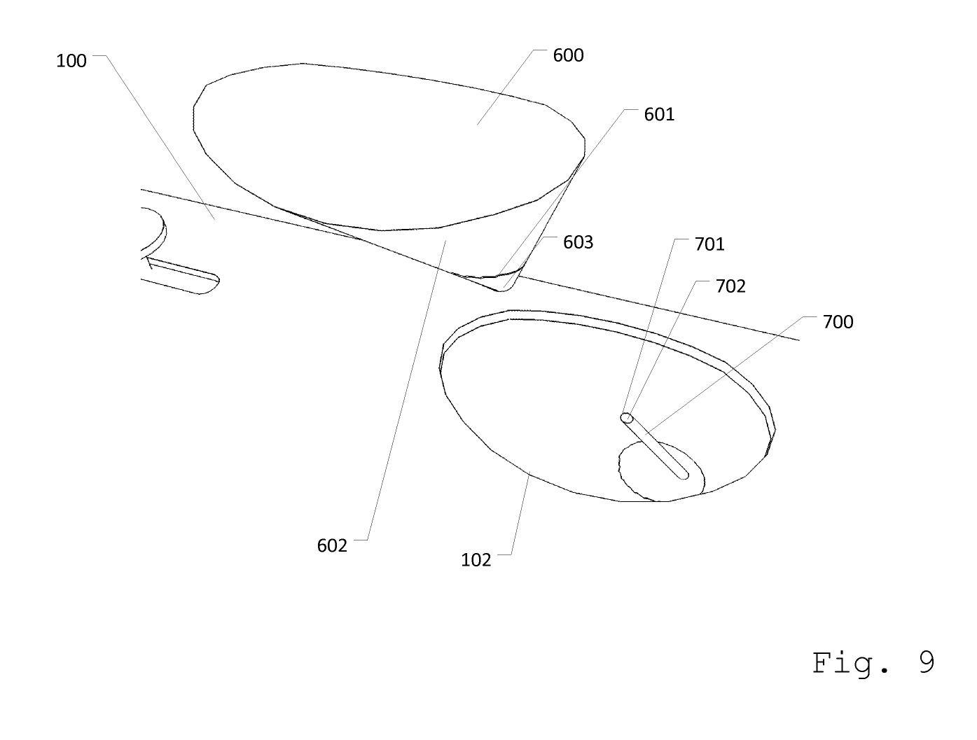

FIG. 9 illustrates cartridge 600 mounted into airbrush 100 on to puncture device 700. Puncturable tip 601 can be mounted directly onto puncture device 700. Sharp tip 701 can puncture puncturable tip 601 creating opening 603. The liquid content within body 602 can then flow out from opening 603 and be released into hole 702 of puncture device 700. In another embodiment wherein puncturable tip 601 of cartridge 600 can be re-sealable, rubber stopper 801 can first be mounted into reservoir 102. Puncture device 700 can then puncture rubber stopper 801 creating opening 603 on rubber stopper 801. This can allow liquid content within body 602 to flow within airbrush 100.

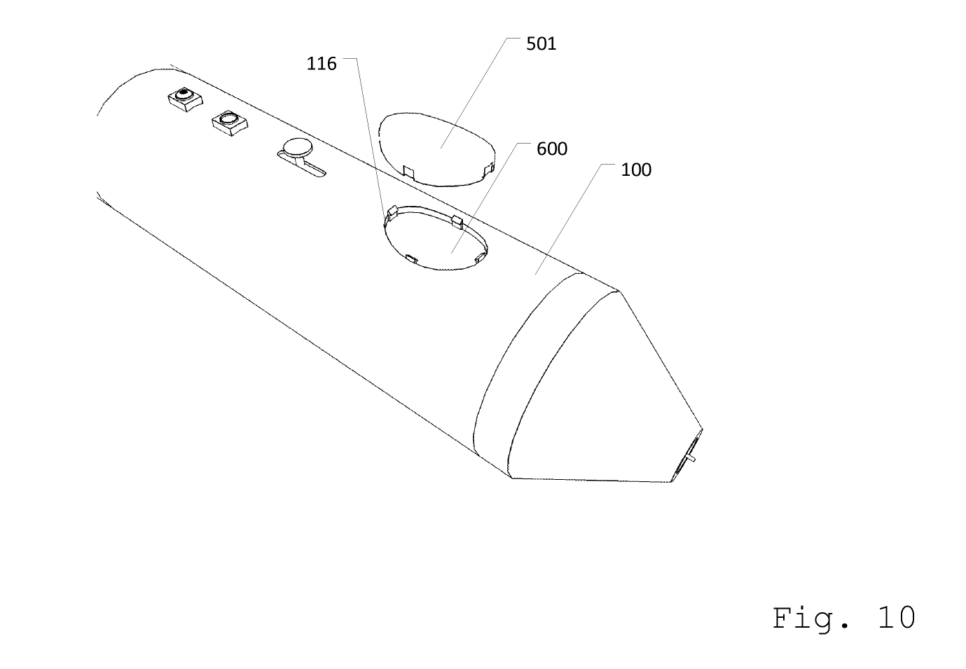

FIG. 10 illustrates an embodiment of cartridge 600 held in reservoir 102 with a plurality of mounting brackets 1001. Mounting brackets 1001 can protrude from the top edge of dish 116. In this such embodiment, mounting brackets 1001 can secure cartridge 600 in place. In one embodiment, cover 501 can be mounted on top of mounting brackets 1001. This can prevent small particles from entering reservoir 102. Cover 501 can be removable from reservoir 102, in one embodiment. In such embodiment, cover 501 can fit snugly around mounting brackets 1001.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An improved airbrush comprising
a housing comprising a front housing and a back housing;
an airbrush assembly mounted on or within said front housing; said airbrush assembly comprising
a reservoir;
a trigger;
a nozzle placed at the front end of said front housing in fluid connection with aid reservoir;
a needle that connects said reservoir, said nozzle and said trigger, said nozzle placed at the front end of said needle, said reservoir at the middle section of said needle, said trigger near the back end of said needle; and
an air valve mounted within said front housing, said air valve vertically connected with said trigger; and
an air pump mounted within the inner surface of said back housing, said air pump comprising an inlet and an outlet, said outlet directly connected below said air valve.

2. The system of claim 1 wherein the inner surface of said back housing further comprises a battery, further wherein said battery connected to said air pump.

3. The system of claim 2 wherein said battery connected beside said air pump such that said back housing horizontally connected to said front housing.

4. The system of claim 3 wherein said trigger is mounted to a top portion of said housing.

5. The system of claim 2 wherein said battery is connected at the bottom of said air pump such that said back housing vertically perpendicular with said front housing.

6. The system of claim 5 wherein said trigger is mounted below said front housing.

7. The system of claim 2 wherein said battery is accessible at the outer surface of said back housing through a charging port.

8. The system of claim 1 wherein said front housing is unibody with said back housing.

9. The system of claim 1 wherein said front housing is separable and connectable with said back housing.

10. The system of claim 9 wherein said back housing comprises a fastening device that surrounds the back end portion of said front housing.

11. The system of claim 1 wherein said reservoir is mounted within the inner surface of said front housing.

12. The system of claim 11 wherein said reservoir further comprises a plurality of mounting brackets, said mounting brackets protrudes from the top edge of said reservoir.

13. The system of claim 11 wherein said reservoir further comprises a cover, said cover is mountable at the top of said reservoir.

14. The system of claim 1 wherein said reservoir further comprising a puncture device, said puncture device positioned on top of said reservoir.

15. The system of claim 1 wherein outer surface of said back housing further comprises an on/off switch.

16. The system of claim 1 wherein outer surface of said back housing further comprises an air pump regulator.

17. The system of claim 1 wherein said air pump comprises a MPD-24A mini air pump.

18. The system of claim 1 wherein said air pump comprises a BTC miniature diaphragm pumps and compressors.
